(19) United States
(12) Patent Application Publication
(10) Pub. No.: US 2025/0363892 A1
(43) Pub. Date: Nov. 27, 2025

(54) METHOD FOR OPERATING A VEHICLE, AND VEHICLE

(71) Applicant: Ford Global Technologies, LLC, Dearborn, MI (US)

(72) Inventors: Mohamed Benmimoun, Köln (DE); Muhammad Adeel Awan, Aachen (DE); Ahmed Benmimoun, Aachen (DE); Mohsen Lakehal-ayat, Aachen (DE)

(73) Assignee: Ford Global Technologies, LLC, Dearborn, MI (US)

(21) Appl. No.: 19/215,941

(22) Filed: May 22, 2025

(30) Foreign Application Priority Data
May 23, 2024 (DE) 102024114461.0

(51) Int. Cl. G08G 1/16; B60Q 5/00; B60Q 9/00; G06V 20/58; G08B 21/18

(52) U.S. Cl. CPC G08G 1/166; B60Q 5/006; B60Q 9/008; G08B 21/182; G06V 20/58

(57) ABSTRACT

A vehicle and method for operating thereof. The vehicle comprises a control device, a communication device, and a sensor device. Environmental data are acquired by the sensor device. A communication signal from a mobile device of a user of the vehicle located outside the vehicle is received by the communication device. An object position and/or an object trajectory of one object arranged in the environment of the vehicle is determined. A user location and/or a user trajectory of the user of the vehicle located outside the vehicle are determined. AN expected distance change between the one object position and/or object trajectory and the user location and/or the user trajectory is determined by the control device. The outputting of an alert signal is triggered by the control device if one expected distance change is such that a distance between the one object and the user falls below a threshold value.

### CROSS-REFERENCE TO RELATED APPLICATIONS

The present application claims priority to and the benefit of German Application No. 102024114461.0, filed May 23, 2024, which is hereby incorporated by reference herein in its entirety.

### FIELD

The disclosure relates generally to a method for operating a vehicle, and to a vehicle.

### BACKGROUND

The development of the automatic lateral and longitudinal control of vehicles has made it possible to assist the driver in various situations. In recent years, these situations have been diversified, from assisting the driver with the task of driving while the driver is still inside the vehicle interior, to situations in which the driver/user is also able to leave the vehicle. With the introduction of a higher degree of automation, it is also no longer necessary for the driver/user to monitor the movement of the vehicle. Autonomous driving functionalities are thus nowadays possible in many situations. For example, an autonomous driving function can concern a tracking mode of a parcel or mail delivery agent, so that the vehicle follows the delivery agent autonomously without the delivery agent repeatedly having to steer the vehicle manually himself. The automation of the vehicle avoids the need for the user to repeatedly get into the vehicle, drive it and get out of it when he moves the vehicle to the next location.

Because the delivery agent, as a result of the autonomous driving functions, is able to devote himself to other tasks, for example the actual delivery activities, he can be distracted and may potentially take only rudimentary notice of the traffic situation. Consequently, conflict situations between the delivery agent and other objects of the traffic situation, for example other road users, can potentially occur.

In this connection, U.S. Pat. No. 10,068,473 B1 discloses a method in which a vehicle occupant is alerted to an object by means of a notification. However, only vehicle occupants are alerted when distances may potentially fall below minimum distances. The field of application of previous methods is thus limited.

There is therefore a need to eliminate or at least reduce the disadvantages of known methods for operating a vehicle and vehicles. In particular, there is a need to provide a method and a vehicle that is adapted for a wider spectrum of applications, for example also for situations in which the actual vehicle user is no longer in the vehicle interior.

### SUMMARY

The object is achieved by the subject matter of the independent patent claims. Advantageous embodiments are indicated in the dependent patent claims and the following description, each of which can illustrate aspects of the disclosure on its own or in (sub-) combination. Some features are explained in relation to methods, others in relation to devices. The corresponding aspects are, however, mutually applicable in a corresponding manner.

According to one aspect, some embodiments of the disclosure relate to a method for operating a vehicle. The vehicle comprises at least a control device, a communication device and a sensor device. The control device is coupled at least with the communication device and the sensor device. The method comprises at least the following steps:

Environmental data of an environment of the vehicle are acquired by means of the sensor device.

At least one communication signal is received by the communication device from a mobile device of a user of the vehicle, said user being located outside the vehicle.

At least one object position and/or at least one object trajectory of at least one object arranged in the environment of the vehicle is determined by the control device on the basis of the acquired environmental data.

A user location and/or a user trajectory of the user of the vehicle, said user being located outside the vehicle, are/is determined by the control device on the basis of the received communication signal.

At least one expected distance change between the at least one object position and/or object trajectory and the user location and/or the user trajectory is determined by the control device.

The outputting of an alert signal is triggered by the control device if at least one expected distance change is such that a distance between at least one object and the user falls below a threshold value.

The method is based on the finding that the vehicle user can also be identified outside the vehicle, for example by means of a corresponding communication link. Consequently, it is possible to determine potential conflict situations between the vehicle user and other objects in the environment of the vehicle even when the vehicle user himself is not inside the vehicle interior. Advantageously, the potential conflict situations can be identified using devices of the vehicle itself, such as, for example, sensor or communication devices. There is thus provided a method which, compared to known approaches, can be used for a large number of additional application scenarios.

According to one aspect, some embodiments of the disclosure relate to a vehicle having at least a control device, a communication device and a sensor device. The control device is coupled at least with the communication device and the sensor device. The sensor device is adapted to acquire environmental data of an environment of the vehicle. The communication device is adapted to receive at least one communication signal from a mobile device of a user of the vehicle, said user being located outside the vehicle. The control device is adapted:
to determine, on the basis of the acquired environmental data, at least one object position and/or at least one object trajectory of at least one object arranged in the environment of the vehicle,
to determine, on the basis of the received communication signal, a user location and/or a user trajectory of the user of the vehicle, said user being located outside the vehicle,
to determine at least one expected distance change between the at least one object position and/or object trajectory and the user location and/or the user trajectory, and
to trigger the outputting of an alert signal if at least one expected distance change is such that a distance between at least one object and the user falls below a threshold value.

The advantages which are achieved by the method described herein are also achieved in a corresponding manner by the electronic steering system.

Optionally, the communication device is adapted to permit bidirectional communication with an external mobile device. Communication data can thus be both received and transmitted.

Preferably, the communication device is adapted to communicate by means of at least one communication standard from WLAN, Bluetooth, ultra-wideband, 4G, LTE (long term evolution), 5G or 6G.

The vehicle can also comprise different communication devices for the various communication standards.

In some embodiments, the sensor device is adapted to detect the environment of the vehicle on the basis of at least one of radar, lidar or visual detection, such as an optical camera. The environment can thus be detected in respect of potential objects on the basis of different detection techniques, so that the accuracy is also increased.

The vehicle can of course also comprise multiple mutually complementary sensor devices, which are of the same type or are different and which are each coupled with the control device.

The sensor devices are adapted to transmit corresponding measured data or measurement signals to the control device.

In some embodiments, the mobile device is a smartphone, tablet, handheld device, laptop or the like.

The control device is adapted to retrieve from the communication signal received from the user's mobile device location information stored in the communication signal. On the basis of the location information, the control device determines the user location and/or the user trajectory.

In order that the communication signal includes the user's location information, a dedicated communication routine can also be used by the control device and the mobile device, for example within an application (app) customized to the method.

The object can be stationary objects within the particular traffic situation, but it can also be other road users such as pedestrians or cyclists. Another vehicle can of course also be detected as the object, regardless of whether the vehicle is moving or whether the vehicle is stationary. In addition, the object can also be environment areas of the particular traffic situation, for example cycle paths, crossings, traffic light areas, crossroads areas, lane boundaries or the like.

The object trajectory is to be understood as being the direction of movement of the object, taking account of the detected environment. The object trajectory represents the actual direction of movement of the object, that is to say the path of movement actually traveled by the object within a detection interval, which has been detected by the environmental data.

Preferably, the control device is adapted to determine, on the basis of the object trajectory, an assumed future object trajectory of the object. For example, the control device can use an interpolation method to predict the evolution of the object trajectory for a prediction interval. In the simplest case, the speed and direction of the movement of the object can be assumed to be constant. Specialized prediction models are of course also possible.

In a corresponding manner, the user trajectory is to be understood as being the actual path of movement traveled by the user within the detection interval, which the control device can determine on the basis of one or more communication signals.

Optionally, an assumed future user trajectory of the user is also determined in respect of the user by the control device on the basis of the user trajectory. An interpolation method can likewise be used here.

Preferably, the detection interval and the prediction interval are each individually predefined or variable. For example, the intervals can be dependent on the available environmental data of the sensor device. Likewise, the intervals can be dependent in terms of their length on the number of sensor devices. If, for example, multiple sensor devices are present and the data acquired thereby can be used for determining objects, then the intervals can in principle be shorter than would be the case if there was only one or a small number of sensor devices. This is because the multiple sensor devices ensure greater accuracy and reliability as well as mutual redundancy in the detection of the objects.

Preferably, the expected distance change is predicted on the basis of the actual distance change, which can be carried out by the control device on the basis of the object trajectory and user trajectory actually traveled, or the evolution of the object location relative to the user location. In this respect too, the control device can use an interpolation method in order to determine the future expected distance change.

Alternatively, or cumulatively, the control device also determines the expected distance change on the basis of the assumed future object trajectory and user trajectory.

The alert signal enables the user and optionally also other road users to become aware that a collision of the user with the object could potentially occur. In this respect, the user and optionally other road users can become aware, on the basis of the alert signal, that they can or should adapt their behavior, for example their movement trajectories, accordingly in order to prevent a collision.

Optionally, multiple object positions or object trajectories of multiple objects arranged in the environment of the vehicle are determined by the control device on the basis of the acquired environmental data. An expected distance change between the respective object and the user is then determined by the control device for each object. This means that the control device not only determines the expected distance change in respect of, for example, the closest object relative to the vehicle, but also comprehensively assesses the traffic situation in respect of a possible collision with the user, so that the reliability in respect of the outputting of a corresponding alert signal is increased for all road users.

Preferably, the alert signal is transmitted by means of the communication device to the mobile device of the user, to mobile devices of objects and/or to other vehicles. The user thus receives a notification in respect of the alert signal directly via the mobile device, so that the likelihood of the user perceiving the alert signal is increased.

Alternatively, or cumulatively, the alert signal is outputted by means of an output device of the vehicle. The alert signal can thus likewise be perceived by other road users or by the user if he does not perceive the alert signal on his mobile device, for example because he is distracted.

In a further alternative, the alert signal can also be transmitted to further mobile devices of objects or to other vehicles. A large number of road users can thus be alerted to the potential collision.

In some embodiments, the output device comprises a lighting device and/or a loudspeaker. The alert signal can thus be perceived both visually and acoustically by corresponding road users or by the user. The likelihood of corresponding road users or the user perceiving the alert signal is thus increased. The loudspeaker can be, for example, a horn of the vehicle.

The vehicle can of course also comprise multiple output devices, which together output the alert signal.

Optionally, the threshold value is predefined or variable. Preferably, the threshold value is variable. In the case of a predefined threshold value, the outlay for performing the method is reduced. By means of a variable threshold value, the situation conditions of the particular traffic situation can be taken into account more appropriately.

In some embodiments, the control device determines an object speed of the at least one object and/or a user speed of the user. The threshold value is then optionally dependent at least also on the object speed and/or the user speed. It is thus possible, for example, to take account of the fact that, at a higher object speed, a greater distance is traveled within the reaction time of the user or of the object if the object is a road user.

Preferably, the threshold value is dependent at least also on dimensions of an imaginary person corridor in the center of which the user is positioned. A notional volume can thus be assumed by the control device as an aid, within which volume a collision with the object is to be regarded as having to be prevented. It can thus be ensured, for example, that a personal space of the user remains as free of objects as possible.

In an alternative approach, the threshold value is dependent on the relative speed between the detected object and the user. If the relative speed is high, then a threshold value that tends to be higher can be used in order to reflect, in respect of the user, a person corridor with greater dimensions. If the relative speed between the user and the detected object is low, then the threshold value can tend to be small.

Optionally, the threshold value can also be dependent on other parameters, such as, for example, the weather conditions, visibility conditions, the number of detected objects in the environment of the vehicle and the environment scenario. The environment scenario is to be understood as being, for example, the road type. For example, in a situation in which the vehicle is arranged in the region of a main road, a larger threshold value can be used than is the case when the vehicle is arranged in the region of a side road with traffic calming.

In some embodiments, the expected distance changes are also determined for objects in the case of which at least one further object is arranged between the respective object and the user. This means that the expected distance changes are also determined for objects that are concealed from the view of the user by additional objects and that the user thus cannot see directly per se, for example because the user is in a loading area of the vehicle without windows. The benefits of the method are thus increased further, since indirect object-user distances are also evaluated by the method.

Optionally, the alert signal includes behavior information. For example, the alert signal, if it is sent to the mobile device of the user, can include the request to adapt, for example stop, the movement path or the speed. In other scenarios, the alert signal can contain the behavior information to perform or not to perform specific tasks in respect of the vehicle, for example to keep specific doors closed or to open doors only from outside. User comfort and the reliability in the prevention of a collision between the object and the user are thus increased.

The behavior information can be outputted as a voice command in the case of audio signals.

If the alert signal is outputted by an output device of the vehicle, the behavior information can be imparted, for example, on the basis of a spoken announcement of the environment of the vehicle. Other road users can thus also be informed on the basis of the behavior information that a collision with the user is preventable by a specific behavior.

Preferably, the control device, in dependence on the alert signal, additionally triggers at least one disabling signal in respect of a vehicle component. For example, the control device can trigger a disabling signal such that specific doors cannot be opened from inside. To this end, the control device can be coupled with a higher-level driving control device of the vehicle, said higher-level driving control device ultimately performing the corresponding disabling function on the basis of the disabling signal. This also makes it possible to reliably prevent a collision between the object and the user.

In some embodiments, the alert signal includes user location information of the user of the vehicle, said user being located outside the vehicle. The user location information can be made available for the user on his mobile device in the form of an area map, for example. Corresponding objects for which the expected distance change has fallen below the threshold value can then be marked on the area map. Other objects can of course also be marked on the area map, even if the expected distance change thereof has not fallen below the threshold value.

Alternatively, the vehicle can comprise a display device that is visible from outside and on which the user location information is displayed for other road users.

In a further alternative, the user location information can also be indicated on the basis of a specific light pattern, which is made visible for other road users by an output device, for example a vehicle lighting system.

Optionally, a user identification of the user of the vehicle is carried out at the start of the method at least on the basis of a bidirectional communication link between the communication device and the mobile device of the user and/or on the basis of sensor data of the sensor device of the vehicle. The user identification can be carried out, for example, as part of a predefined process by which the user logs in to the control device of the vehicle by means of the mobile device. The user can thus reliably be distinguished from other objects and thus determined in the environment of the vehicle by the control device on the basis of received communication signals and/or on the basis of acquired environmental data. This allows the user to be tracked in the environment of the vehicle on the basis of received communication signals or acquired environmental data.

Optionally, the method is configured as a computer-implemented method. This means that the method steps can be performed with the assistance of one or more data processing devices. In particular, a data processing device can trigger or perform the corresponding steps.

According to a further aspect, the disclosure relates also to a computer program product comprising commands which, when the program is executed by a computer, cause the computer to perform the method as described herein. The advantages achieved by the method described herein are also achieved in a corresponding manner by the computer program product.

According to an additional aspect, the disclosure relates also to a computer-readable storage medium comprising commands which, when the program is executed by a computer, cause the computer to perform the method as described herein. The advantages achieved by the method described herein are also achieved in a corresponding manner by the computer-readable storage medium.

Within the context of the disclosure, vehicles can include in particular land vehicles, namely, inter alia, off-road and road vehicles such as passenger cars, buses, trucks and other commercial vehicles. Vehicles can be manned or unmanned. Vehicles can be at least partially electrically driven, comprise a combustion engine and/or an electric motor serving to drive them.

Optionally, the vehicle can be in particular a delivery vehicle and/or transport vehicle, which is provided for the delivery of goods.

All the features explained in relation to the various aspects can be combined individually or in (sub-) combination with other aspects.

### BRIEF DESCRIPTION OF THE DRAWINGS

The disclosure as well as further advantageous embodiments and developments thereof will be described and explained in greater detail hereinbelow with reference to the examples shown in the drawings, in which:

FIG. 1 shows a simplified schematic representation of a vehicle according to one embodiment and of a mobile device,

FIG. 2 shows a simplified schematic representation of a method for operating a vehicle, and

FIG. 3 shows a simplified schematic representation of a possible application scenario in connection with the method.

### DETAILED DESCRIPTION

The following detailed description in conjunction with the accompanying drawings, in which identical numerals relate to identical elements, is intended as a description of different embodiments of the disclosed subject matter and is not to represent the individual embodiments. Each embodiment described in this disclosure serves merely as an example or illustration and is not to be interpreted as being preferred or advantageous over other embodiments. The illustrative examples contained herein do not claim to be complete and do not limit the claimed subject matter to the precise disclosed forms. Various modifications of the described embodiments are readily identifiable to a person skilled in the art, and the general principles defined herein can be applied to other embodiments and applications without departing from the spirit and scope of the described embodiments. Therefore, the described embodiments are not limited to the embodiments shown but have the greatest possible scope of application that is compatible with the principles and features disclosed herein.

All the features disclosed hereinbelow in relation to the exemplary embodiments and/or the accompanying figures can be combined on their own or in any desired sub-combination with features of the aspects of the disclosure, including features of preferred embodiments, provided that the resulting feature combination is meaningful to a person skilled in the technical field.

For the purposes of the disclosure, the wording “at least one of A, B and C” means, for example, (A), (B), (C), (A and B), (A and C), (B and C) or (A, B and C), including all further possible combinations if more than three elements are listed. In other words, the expression “at least one of A and B” generally means “A and/or B”, namely “A” on its own, “B” on its own or “A and B”.

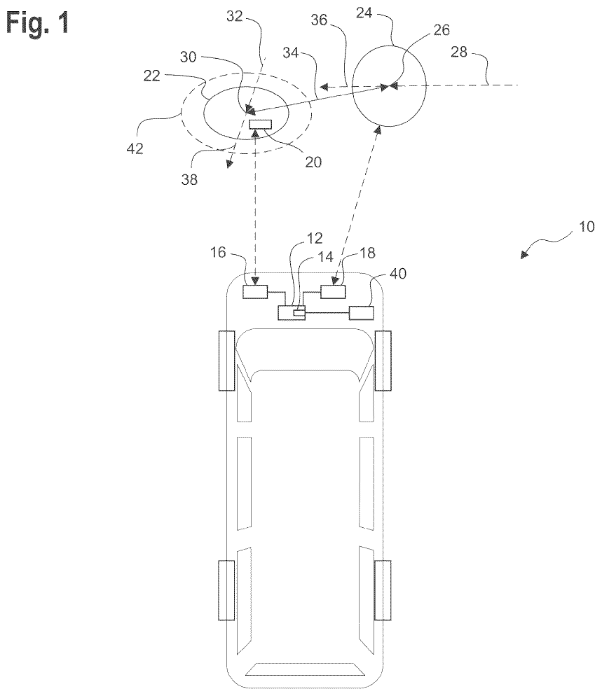

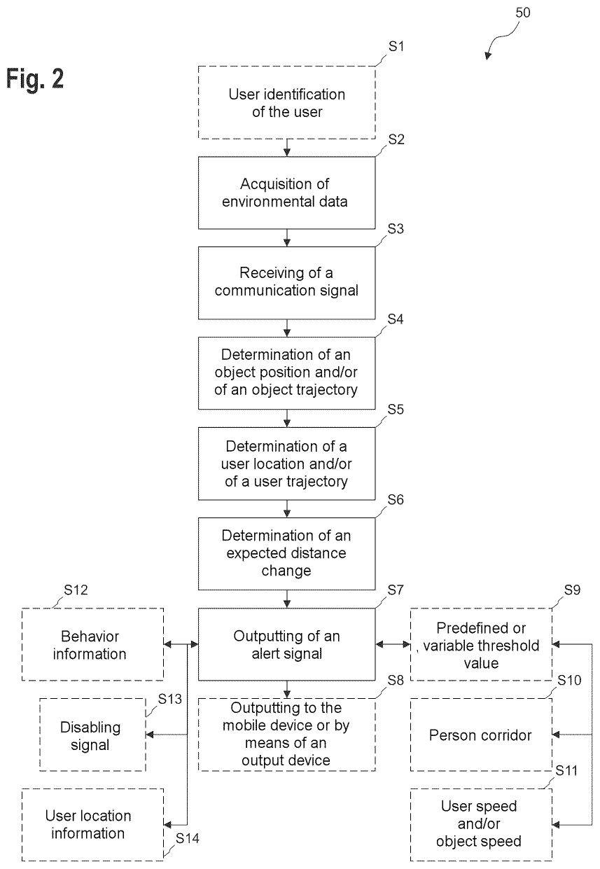

FIG. 1 shows a simplified schematic representation of a vehicle 10 according to one embodiment and of a mobile device 20, which is used by a user 22 of the vehicle 10 for the method 50 illustrated in FIG. 2 and for other activities.

The vehicle 10 comprises a control device 12 having at least a data processing device 14. The control device 12 is coupled with a communication device 16 and with at least one sensor device 18. The communication device 16 can also be internal to the control device 12.

In this connection, FIG. 2 shows a simplified schematic representation of a method 50 for operating the vehicle 10 according to one embodiment. Optional steps are shown by broken lines.

In the optional step S1, a user identification is carried out between a user 22 of the vehicle 10 and the control device 12 on the basis of a bidirectional communication between the communication device 16 and the mobile device 20 of the user. Alternatively or in addition, sensor measured values acquired by the sensor device 18 can also be used for the user identification. For example, the sensor device 18, if it uses camera-based technology, can record an image of the user 22, on the basis of which the user can later repeatedly be recognized. Repeated user identifications can thus be avoided. By means of the user identification, the control device 12 is informed of the communication signals, namely those of the mobile device 20, on the basis of which the user 22 can be recognized again. For the user identification, the user 22 can be positioned inside or outside the vehicle interior of the vehicle 10.

In step S2, environmental data of an environment of the vehicle 10 are acquired by means of the sensor device 18. This means that the sensor device 18 is adapted to acquire sensor measured values in respect of an environment of the vehicle 10. In the present case, the sensor device 18 is adapted to acquire sensor measured values on the basis of lidar. Other sensor technologies are likewise conceivable, for example camera-based devices or radar.

In step S3, at least one communication signal sent by the mobile device 20 of the user 22 of the vehicle 10 is received by the communication device 16 of the vehicle 10. The user 22 does not need to be located in a vehicle interior but can likewise be positioned externally to the vehicle 10. The communication signal received by the communication device 16 is transmitted to the control device 12. In the present case, the communication device 16 is adapted to receive communication signals on the basis of Bluetooth. Other wireless transmission techniques are of course likewise conceivable, such as, for example, WLAN or a mobile communication standard.

In the following step S4, the control device 12 determines objects 24 in an environment of the vehicle 10 on the basis of the received sensor measured values, that is to say acquired environmental data. This means that the objects 24 are determined on the basis of the environmental data acquired by the sensor device 18. The control device 12 is here adapted to determine an object position 26 of the object 24 at a specific time. In addition, the sensor device 18 detects the object 24 within a detection interval. This means that the sensor device 18 is able to acquire, for example, multiple sensor measured values in respect of the object 24 within the detection interval. On the basis of the multiple sensor measured values, the control device 12 can be adapted to determine an object trajectory 28 that is actually traveled by the object 24 within the detection interval, that is to say a movement, including speed and direction, that the object 24 has demonstrably (on account of the acquired sensor measured values) traveled within the detection interval.

The object 24 can be, for example, other road users, such as cyclists or pedestrians. However, the object 24 can also be rigid objects such as boundaries, roadway lighting, stationary vehicles or the like.

Although only a single object 24 is shown in FIG. 1, in step S4 the control device 12 of course determines, on the basis of the received sensor measured values, the object position 26 and/or the object trajectory 28 for a large number of different objects 24 in the environment of the vehicle 10.

In step S5, the control device 12 determines, on the basis of the communication signal received from the mobile device 20, a user location 30 of the user 22, even though the user 22 is positioned outside a vehicle interior. Likewise, a detection interval can also be used in respect of the user 22 to receive multiple communication signals of the mobile device 20 by the migration device 16 within the detection interval. By means of the multiple communication signals, the control device 12 can determine a user trajectory 32 that the user 22 has actually traveled within the detection interval. In an alternative, the user trajectory 32 can also be indicated in the transmitted communication signal.

In the following step S6, at least one expected distance change 34 between the at least one object position 26 and/or object trajectory 28 and the user location 30 and/or the user trajectory 32 is determined by the control device 12.

In order to increase the accuracy in the determination of the expected distance change 34, the control device 12 can also determine an expected object trajectory 36 of the object 24. For example, the expected object trajectory 36 can be interpolated by the control device 12 on the basis of the object trajectory 28 actually traveled within the detection interval. In a corresponding manner, the control device 12 can determine an expected user trajectory 38 of the user 22, for example likewise on the basis of an interpolation of the user trajectory 32 actually traveled within the detection interval. The expected distance change 34 can thus be determined taking account of the assumed future movement of the object 24 and of the user 22, so that the prediction accuracy is increased.

Within step S6, the expected distance changes 34 are of course determined for all detected objects 24 in the environment of the vehicle 10.

In the following step S7 of the method 50, the outputting of at least one alert signal is triggered by the control device 12 if at least one expected distance change 34 is such that a distance between at least one object 24 and the user 22 falls below a threshold value. In other words, the threshold value is used as the reference value starting from which a collision between the user 22 and the object 24 is largely probable. In this respect, if the distance falls below the threshold value, this has the result that the control device 12 takes measures to prevent such a collision where possible. The alert signal is therefore adapted such that the user 22 and/or the object 24 is alerted to the potential collision.

The outputting of an alert signal triggered in step S7 can be configured in different ways. For example, according to the optional step S8, the alert signal can be effected by communication between the communication device 16 and the mobile device 20 and then by means of an output device of the mobile device 20. Consequently, the user 22 can receive a notification on his mobile device 20. Alternatively or cumulatively, the mobile device 20 can also output an audio signal, a visual signal and/or a haptic signal for the user 22 in respect of the alert signal.

Alternatively, or in addition, the alert signal can also be outputted in accordance with step S8 by means of an output device 40 of the vehicle 10. According to the embodiment of FIG. 1, the output device 40 of the vehicle 10 is a loudspeaker. Alternatively or cumulatively, the output device 40 can, however, also comprise a display device or a lamp, so that a visual signal can be outputted.

The method 50 can be enhanced by additional optional steps. For example, the threshold value used in step S7 can be predefined in accordance with step S9. The outlay for evaluation by the control device 12 is thus very low.

In an alternative, the threshold value can, however, also be variable and then adapted, for example, to the particular circumstances of the situation.

For example, in accordance with the optional step S10, the threshold value can be dependent at least also on a person corridor 42 that is notionally taken into account around the user 22, in particular on the dimensions of said person corridor. The person corridor 42 represents a region in the center of which the user 22 is positioned and for which overlapping with the object 24 is to be prevented where possible. The dimensions of the person corridor 42 can be predefined or can themselves be variable. For example, the dimensions of the person corridor 42 can be dependent on a speed of the user 22, which can be determined by the control device 12 on the basis of the received communication signal of the mobile device 20.

Alternatively, or cumulatively, in accordance with the optional step S11, the threshold value can be dependent on a user speed of the user 22 and/or on an object speed of the object 24. As already explained, the user speed of the user 22 can be determined by the control device 12 on the basis of the received communication signals of the mobile device 20 of the user 22. The object speed of the object 24 can be determined by the control device 12 in a corresponding manner on the basis of the sensor measured values which the sensor device 18 acquires in respect of the object 24. This opens up the possibility of providing higher threshold values, in particular in the case of high relative speeds between the user 22 and the object 24, so that larger tolerance ranges are taken into account. By contrast, in the case of lower relative speeds, lower threshold values can be provided, so that the prediction accuracy in respect of a possible collision between the user 22 and the object 24 can be increased, since the variance of the prediction is reduced.

In accordance with the optional step S12, the alert signal triggered in step S7 of the method 50 can also contain behavior information. For example, audio signals or visual signals can include corresponding instructions to the user 22 and/or the object 24, said instructions being suitable for preventing a collision between the user 22 and the object 24. The behavior information can include, for example, the adaptation of the movement direction or speed, such as, for example, a prompt to stop or the like. The behavior information can also include the instruction to perform or not to perform specific tasks, for example to keep specific doors of the vehicle 10 closed or to open specific doors only from outside. The behavior information can be outputted as voice commands and/or as text.

The method 50 can also be enhanced by the optional step S13, in which the control device 12, in the course of the triggering of the alert signal, additionally triggers a disabling signal. The disabling signal can be adapted to perform a specific functionality in respect of the vehicle 10. For example, the disabling signal can be outputted by the control device 12 to a vehicle control device, which as a consequence locks specific doors of the vehicle 10 so that they cannot be opened, at least temporarily, from an interior of the vehicle 10.

In accordance with the optional step S14, the alert signal can also include user location information. For example, the alert signal, if it is an audio signal, can indicate that the user 22 is at a specific position or is moving in a specific direction. If it is a visual signal, the user location information can be imparted, for example, by a frequency modulation and/or amplitude modulation (e.g. flashing). Objects 24 at the location of the user 22 can thus be pointed out.

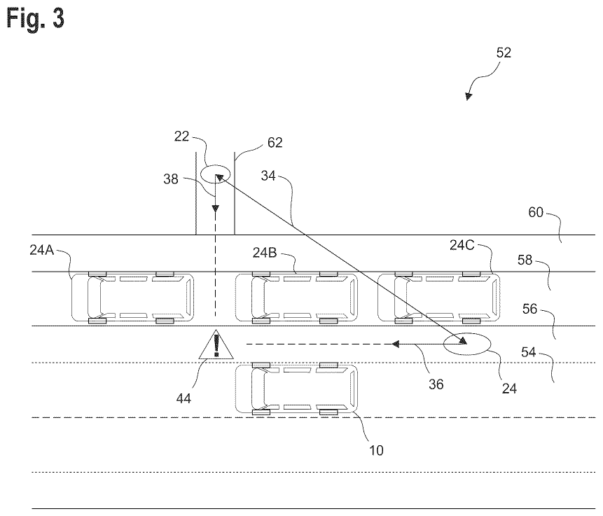

In this connection, FIG. 3 shows an exemplary application scenarios of the method 50.

FIG. 3 shows an application scenario 52 in which the user 22 has delivered a parcel and is now returning to his vehicle 10 in order to fetch his next delivery. While the user 22 is returning to the vehicle 10, he is generally occupied with inputting the required information into the management system or looking for his next delivery information, while he crosses a cycle path with an approaching bicycle.

The vehicle 10 of the user 22 is parked on a road lane 54. Adjacent to the road lane 54 there is a cycle path 56, on which an object 24 (cyclist) is approaching. Adjacent to the cycle path 56 there is a parking lane 58, in which further objects 24A to 24C (parked vehicles) are positioned. Adjacent to the parking lane 58 there is a footpath 60, from which there leads a house access path 62 along which the user 22 is moving.

The control device 12 determines the expected distance change 34 between the user 22 and the object 24, even though further objects, for example the stationary object 24B, are positioned between the user 22 and the object 24. It can thus be determined whether a collision between the user 22 and the object 24 can occur at a meeting point 44. In this respect, the control device 12 takes account of a threshold value and, according to this embodiment, also of the expected object trajectory 36 and the expected user trajectory 38. If the expected distance change 34 falls below the threshold value, the control device 12 triggers the outputting of an alert signal to the user 22 and the object 24.

It is particularly clear here that the alert signal can both be outputted to the mobile device 20 of the user 22, so that the user 22 is immediately alerted to the possible collision at the meeting point 44, and that an output device of the vehicle 10 itself can be used in order to alert other objects 24, for example road users, to the collision. For example, a loudspeaker or a turn indicator or a lighting element of the vehicle 10 can be used to alert the object 24 traveling on the cycle path 56 to the collision. The alert signal can then also contain corresponding behavior information in order, for example, to signal to the cyclist that the collision is preventable by changing route or speed.

In this situation it is also illustrated, by way of example, that a disabling signal can be triggered by the control device 12 in dependence on the particular traffic situation, for example in order to prevent a user 22 from being able to open a door from the interior of the vehicle 10 and thus create an obstacle for an approaching object 24.

All embodiments of the method 50 make it possible to increase the probability of preventing a collision between the object 24 and the user 22.

Specific embodiments disclosed herein use circuits (e.g. one or more circuits) to implement standards, protocols, methods or technologies disclosed herein, to functionally couple two or more components, to generate information, to process information, to analyze information, to generate signals, to encode/decode signals, to convert signals, to transmit and/or to receive signals, to control other devices, etc. Circuits of any kind can be used.

In one embodiment, a circuit such as the control device comprises, inter alia, one or more data processing devices such as a processor (e.g. a microprocessor), a central processing unit (CPU), a digital signal processor (DSP), an application-specific integrated circuit (ASIC), a field-programmable gate array (FPGA), a system on a chip (SoC) or the like or any desired combinations thereof and can comprise discrete digital or analog circuit elements or electronics or combinations thereof. In one embodiment, the circuit comprises hardware circuit implementations (e.g. implementations in analog circuits, implementations in digital circuits and the like as well as combinations thereof).

In one embodiment, circuits comprise combinations of circuits and computer program products with software or firmware commands, which are stored on one or more computer-readable memories and cooperate in order to cause a device to execute one or more of the protocols, methods or technologies described herein. In one embodiment, the circuit technology comprises circuits, such as, for example, microprocessors or parts of microprocessors, which require software, firmware and the like for operation. In one embodiment, the circuits comprise one or more processors or parts thereof and the associated software, firmware, hardware and the like.

Reference may be made in this disclosure to quantities and numbers. Unless explicitly stated, such quantities and numbers are not to be considered to be limiting but rather as examples of the quantities or numbers that are possible in connection with the disclosure. In this connection, the term “plurality” may also be used in the disclosure to refer to a quantity or number. In this connection, the term “plurality” means any number greater than one, for example two, three, four, five, etc. The terms “about”, “approximately”, “close to” etc. mean plus or minus 5% of the stated value.

Although the disclosure has been represented and described in relation to one or more embodiments, a person skilled in the art, after reading and understanding this description and the accompanying drawings, will be able to make equivalent changes and modifications.

That which is claimed is:

1. A method (50) for operating a vehicle (10) having at least a control device (12), a communication device (16) and a sensor device (18), wherein the method (50) comprises at least the following steps:
acquiring environmental data of an environment of the vehicle (10) by the sensor device (18),
receiving by the communication device (16) at least one communication signal from a mobile device (20) of a user of the vehicle (10), said user being located outside the vehicle (10),
determining by the control device (12), on the basis of the acquired environmental data, at least one object position (26) and/or at least one object trajectory (28) of at least one object (24) arranged in the environment of the vehicle (10),
determining by the control device (12), on the basis of the received communication signal, a user location (30) and/or a user trajectory (32) of the user (22) of the vehicle (10), said user being located outside the vehicle (10),
determining by the control device (12) at least one expected distance change (34) between the at least one object position (26) and/or object trajectory (28) and the user location (30) and/or the user trajectory (32), and
triggering the outputting of an alert signal by the control device (12) if at least one expected distance change (34) is such that a distance between at least one object (24) and the user (22) falls below a threshold value.

2. The method (50) according to claim 1, wherein multiple object positions (26) and/or object trajectories (28) of multiple objects (24) arranged in the environment of the vehicle (10) are determined by the control device (12) on the basis of the acquired environmental data, and in that an expected distance change (34) is determined for each object (24).

3. The method (50) according to claim 1, wherein the alert signal is transmitted by the communication device (16) to the mobile device (20) of the user (22), to mobile devices (20) of objects (24) and/or to other vehicles (10), and/or in that the alert signal is outputted by an output device (40) of the vehicle (10).

4. The method (50) according to claim 1, wherein the output device (40) comprises a lighting device and/or a loudspeaker.

5. The method (50) according to claim 1, wherein the threshold value is variable.

6. The method (50) according to claim 1, wherein the control device (12) determines an object speed of the at least one object (24) and/or a user speed of the user (22), and in that the threshold value is dependent at least also on the object speed and/or the user speed.

7. The method (50) according to claim 1, wherein the threshold value is dependent at least also on dimensions of an imaginary person corridor (42) in the center of which the user (22) is positioned.

8. The method (50) according to claim 1, wherein the expected distance changes (34) are also determined for objects (24) in the case of which at least one further object (24) is arranged between the respective object (24) and the user (22).

9. The method (50) according to claim 1, wherein the alert signal includes behavior information.

10. The method (50) according to claim 1, wherein the control device (12), in dependence on the alert signal, additionally triggers at least one disabling signal in respect of a vehicle component.

11. The method (50) according to claim 1, wherein the alert signal includes user location information of the user (22) of the vehicle (10), said user being located outside the vehicle (10).

12. The method (50) according to claim 1, wherein a user identification of the user (22) of the vehicle (10) is carried out at the start of the method (50) at least on the basis of a bidirectional communication link between the communication device (16) and the mobile device (20) of the user (22) and/or on the basis of sensor data of the sensor device (18) of the vehicle (10).

13. A vehicle (10), comprising:
at least a control device (12),
a communication device (16), and
a sensor device (18),
wherein the sensor device (18) is adapted to acquire environmental data of an environment of the vehicle (10), the communication device (16) is adapted to receive at least one communication signal from a mobile device (20) of a user (22) of the vehicle (10), said user being located outside the vehicle (10), and
wherein the control device (12) is configured to:
determine, on the basis of the acquired environmental data, at least one object position (26) and/or at least one object trajectory (28) of at least one object (24) arranged in the environment of the vehicle (10),
determine, on the basis of the received communication signal, a user location (30) and/or a user trajectory (32) of the user (22) of the vehicle (10), said user being located outside the vehicle (10),
determine at least one expected distance change (34) between the at least one object position (26) and/or object trajectory (28) and the user location (30) and/or the user trajectory (32), and
trigger the outputting of an alert signal if at least one expected distance change (34) is such that a distance between at least one object (24) and the user (22) falls below a threshold value.
